(19) United States
(12) Patent Application Publication
(10) Pub. No.: US 2010/0195085 A1
(43) Pub. Date: Aug. 5, 2010

(54) POSITIONING APPARATUS, EXPOSURE APPARATUS, AND DEVICE MANUFACTURING METHOD

(75) Inventor: Naoto Fuse, Utsunomiya-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/700,766

(22) Filed: Feb. 5, 2010

(30) Foreign Application Priority Data
Feb. 5, 2009 (JP) 2009-024853

(51) Int. Cl. G03B 27/58; G01B 11/14

(52) U.S. Cl. 355/74; 356/614

(57) ABSTRACT

A positioning apparatus of the present invention performs a positioning of an object with a predetermined number of degrees of freedom. The positioning apparatus comprises a plurality of drivers whose number is more than that of the degrees of freedom, which are configured to drive the object, a calculator configured to calculate target positions of the plurality of drivers from a target position of the object using a measurement result of a shape of the object previously measured, and a controller configured to control the plurality of drivers so as to come close to the target positions of the plurality of drivers.

### BACKGROUND OF THE INVENTION

1. Field of the Invention

The present invention relates to a positioning apparatus, and more particularly to a positioning apparatus which performs a positioning control of an optical element in an exposure apparatus.

2. Description of the Related Art

Previously, as a positioning apparatus which performs a positioning control of an object using a plurality of actuators, a positioning apparatus including actuators whose number is the same as that of the driving degrees of freedom of the object has been used. However, in such a positioning apparatus, there is a case where a driving force for driving the object is not sufficient or a precompression force of the actuator is not sufficient. Therefore, a positioning apparatus including actuators whose number is more than that of the driving degrees of freedom of the object has been proposed.

Japanese Patent No. 2996121 discloses a parallel mechanism of six degrees of freedom including six actuators. In this document, redundant actuators are used for applying a precompression to these actuators.

However, the redundant actuators as described above are used, an excessive force may be applied to an object that is a positioning target. When the excessive force is applied to the object, it is deformed by the force.

### BRIEF SUMMARY OF THE INVENTION

The present invention provides a positioning apparatus capable of performing a highly accurate control with high rigidity.

A positioning apparatus as one aspect of the present invention performs a positioning of an object with a predetermined number of degrees of freedom. The positioning apparatus comprises a plurality of drivers whose number is more than that of the degrees of freedom, which are configured to drive the object, a calculator configured to calculate target positions of the plurality of drivers from a target position of the object using a measurement result of a shape of the object previously measured, and a controller configured to control the plurality of drivers so as to come close to the target positions of the plurality of drivers.

An exposure apparatus as another aspect of the present invention includes the positioning apparatus.

A device manufacturing method as another aspect of the present invention comprises the steps of exposing a substrate using the exposure apparatus and developing the exposure substrate.

Further features and aspects of the present invention will become apparent from the following description of exemplary embodiments with reference to the attached drawings.

### BRIEF DESCRIPTION OF THE DRAWINGS

FIG. 1 is a schematic configuration diagram of an exposure apparatus in the present embodiment.

FIG. 2 is a configuration diagram of an adjustment mechanism (a positioning apparatus) in Embodiment 1.

FIG. 3 is a configuration diagram of an adjustment mechanism (a positioning apparatus) in Embodiment 2.

FIGS. 4A and 4B are configuration diagrams of a micromotion stage (a positioning apparatus) in Embodiment 3.

FIG. 5 is a control block diagram in a positioning apparatus of the present embodiment.

FIG. 6 is an illustration of a coordinate conversion in the present embodiment.

### DETAILED DESCRIPTION OF THE PREFERRED EMBODIMENTS

Exemplary embodiments of the present invention will be described below with reference to the accompanied drawings. In each of the drawings, the same elements will be denoted by the same reference numerals and the duplicate descriptions thereof will be omitted.

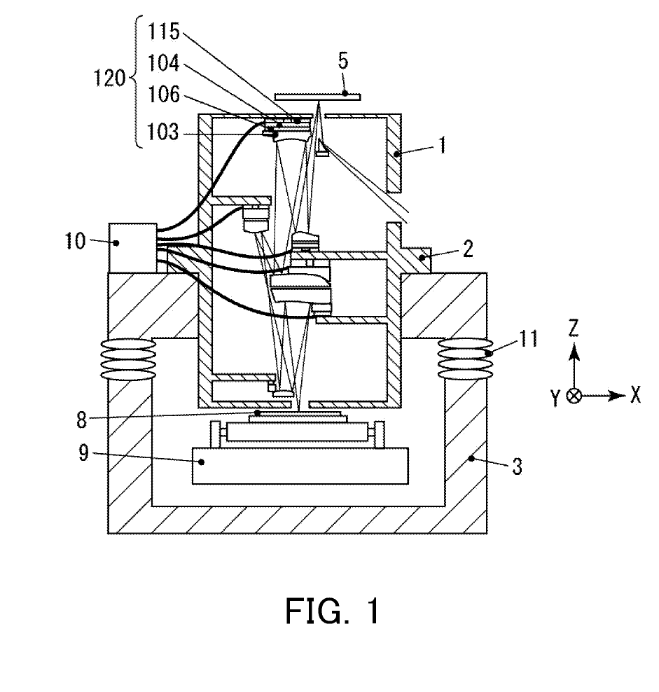

First, an exposure apparatus in the present embodiment will be described. FIG. 1 is a schematic configuration diagram of the exposure apparatus in the present embodiment.

An exposure apparatus 200 of the present embodiment is a projection exposure apparatus which exposes a circuit pattern formed on a reticle 5 (an original plate) onto a wafer 8 (a substrate) using EUV light, which has for example a wavelength of 13.4 nm, as illumination light for exposure. The exposure apparatus of the present embodiment uses the EUV light, but may also uses another light source such as KrF, ArF, or F2.

The exposure apparatus 200 of the present embodiment is a step-and-scan type exposure apparatus, which is referred to also as a “scanner”, suitable for a lithography process of submicron or quarter micron order or less. The “step-and-scan type” means an exposure method where the wafer is continuously scanned with respect to the reticle to expose a mask pattern onto the wafer and a step movement of the wafer is performed after the exposure of one shot is completed to move the wafer to the next exposure region. However, the present embodiment can also be applied to a different type exposure apparatus such as a step-and-repeat type. The “step-and-repeat type” means an exposure method where the step movement of the wafer is performed for one-shot exposure to move the wafer to the next exposure region.

As described above, the positioning apparatus of the present embodiment can also be applied to any types of exposure apparatuses.

As shown in FIG. 1, the exposure apparatus 200 includes an illumination apparatus (not shown), a reticle stage (not shown) which is configured to place the reticle 5, and a wafer stage 9 which is configured to place a wafer 8. The exposure apparatus 200 includes a projection optical system 1 which forms an image (a pattern) of the reticle 5 onto the wafer 8, an alignment detection mechanism (not shown), and a focus position detection mechanism (not shown).

The EUV light has a low transmittance for the air. Therefore, a vacuum atmosphere is formed at least in an optical path where the EUV light passes through, i.e. a whole optical system, in the exposure apparatus 200.

The reticle 5 is a reflective type, and a circuit pattern (or an image) that is to be transferred is formed on the reticle 5. The reticle 5 is supported on and fixed to a reticle stage using an electrostatic chuck or the like. Therefore, the reticle 5 is driven integrally with the reticle stage. Diffractive light emitted from the reticle 5 is reflected on a plurality of optical elements 103 in the projection optical system 1 to be projected onto the wafer 8. The reticle 5 and the wafer 8 are arranged so as to be in an optically conjugate relation with each other. Since the exposure apparatus 200 is the step-and-scan type exposure apparatus, the reticle 5 and the wafer 8 are synchronously scanned to perform a reduced projection of the pattern of the reticle 5 onto the wafer 8.

The projection optical system 1 includes a plurality of optical elements 103, each of which is constituted of a reflective mirror (a multilayer film mirror). The projection optical system 1 uses the plurality of reflective mirrors to perform a reduced projection of the pattern on a surface of the reticle 5 onto the wafer 8 that is an image surface. The number of the plurality of reflective mirrors is around four to eight. As shown in FIG. 1, the exposure apparatus 200 of the present embodiment includes six reflective mirrors. In order to realize a large exposure region with a small number of mirrors around four to eight, only a thin arc-shaped region (a ring field) which is away from an optical axis by a constant distance is used. Then, the reticle 5 and the wafer 8 are simultaneously scanned to transfer the pattern on the surface of the reticle 5 onto a large area on the wafer 8. It is preferable that the number of the reflective mirrors is even number such as four, six, or eight. The numerical aperture (NA) of the projection optical system 1 is around 0.2 to 0.3.

In the exposure apparatus 200, a barrel platen 2 and a base frame 3 are fastened via a vibration-free mechanism 11. Because the exposure apparatus 200 includes the vibration-free mechanism 11, the transfer of a vibration of a setting floor to the projection optical system 1 and also each mirror inside it can be inhibited.

In FIG. 1, reference numeral 120 denotes an adjusting mechanism (a positioning apparatus) which adjusts a position of an optical element. The adjusting mechanism 120 is configured to include an optical element 103, a support frame 104, a holding mechanism 106, and a driver 115. The details of the adjusting mechanism 120 will be described below.

Reference numeral 10 denotes a controller which performs a control of the adjusting mechanism 120 (a positioning control of the optical element 103). Specifically, the controller 10 performs a calculation so that an error amount such as a magnification error obtained from an exposure aberration or alignment information is minimized. Then, it performs a positioning control of the optical element 103 based on the calculation result and a program previously stored. Such a control enables the optical performance of the projection optical system 1 to be optimized. The details of the positioning control of the optical element 103 will be described below.

As a wafer stage 9 of the exposure apparatus 200, a micromotion stage (a positioning apparatus) described below can also be applied.

### Embodiment 1

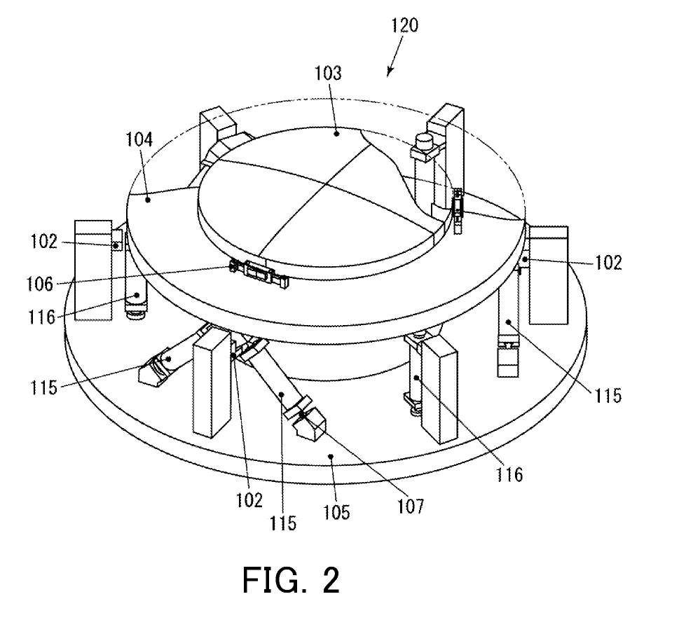

Next, a positioning apparatus in Embodiment 1 of the present invention will be described. FIG. 2 is a configuration diagram of a positioning apparatus (an adjusting mechanism) in the present embodiment.

An adjusting mechanism 120 of the present embodiment is a positioning apparatus which performs a positioning of an object with a predetermined number of degrees of freedom. The adjusting mechanism 120 includes six drivers 115 (actuators) capable of being displaced with respect to a base plate 105 in one axis direction via an elastic hinge 107. The driver 115 is configured so as to drive the object (the optical element 103 and the support frame 104). The adjusting mechanism 120 connects the base plate 105 and the support frame 104 via the driver 115 and the elastic hinge 107. The base plate 105 is for example connected with the projection optical system 1 of the exposure apparatus 200.

As the driver 115, a driver movable in a straight line such as a piezo element (a piezo actuator) or a cylinder is used. The configuration of the adjusting mechanism 120 shown in FIG. 2 is a common configuration example of a parallel mechanism. The adjusting mechanism 120 displaces the six drivers 115 to desired positions to be movable independently with respect to a total of six axes of three axes orthogonal to one another and three rotational axes around these axes. Thus, the optical element 103 (the support frame 104) is movable in the six axes by the respective six drivers 115. In other words, the number of the degrees of freedom of the adjusting mechanism 120 is six.

The optical element 103 is mounted on the support frame 104 via the holding mechanism 106. The holding mechanism 106, as one example, uses the system similar to that of the elastic hinge 107. The system of the holding mechanism 106 is not limited to this, but other systems such as a system using a kinematic mount can also be used (not shown). The holding mechanism 106 reduces an influence on the optical performance caused by transferring a minimal deformation of the support frame 104 when driving the adjusting mechanism 120 to the optical element 103. In addition, the holding mechanism 106 is able to reproducibly mount the optical element 103 with high accuracy. The adjusting mechanism 120 uses a sensor 102 measuring a position and the driver 115 to drive the optical element 103 to perform a fine adjustment.

The adjusting mechanism 120 includes three redundant drivers 116 (drivers) in addition to the six drivers 115. In the present embodiment, the redundant driver 116 has the configuration similar to that of the driver 115, but these may also be configured differently from each other. The number of the degrees of freedom of the adjusting mechanism 120 is six. Therefore, the six drivers 115 are arbitrarily operated to be movable in a total of six axes of three axes orthogonal to one another and three rotational axes around these axes.

However, in the support frame 104 (the optical element 103) that is a driven target, the rigidity of a part where the driver 115 is not connected is weakened. When such a part having the weak rigidity exists, the part becomes antinodes of the natural elastic mode of the adjusting mechanism 120, and therefore the natural frequency of the adjusting mechanism 120 is decreased. In order to avoid the decrease of the natural frequency, generally, a spring is provided at apart that is antinodes of the natural elastic mode (a part having the weak rigidity where the driver 115 is not connected). In this case, however, the rigidity of the spring may prevent the motion of the support frame 104 that is the driven target and deform the support frame 104.

Therefore, in the present embodiment, a redundant driver 116 is provided at a part of the support frame 104 where the driver 115 is not connected so that an excessive force is not applied when driving the support frame 104. The redundant driver 116 is configured to be able to follow the motion of the support frame 104. Thus, the driver 115 (first driver) and the redundant driver 116 (second driver) are configured so as to drive the object (the optical element 103 or the support frame 104).

In the present embodiment, three redundant drivers 116 are provided, but the present embodiment is not limited to this. The adjusting mechanism 120 has only to include drivers (drivers 115, redundant drivers 116) more than the number of the degrees of freedom. Therefore, in the present embodiment, at least one redundant driver has only to be provided.

The adjusting mechanism 120 of the present embodiment includes six sensors 102 (detectors) which measure respective positions. Each of three of the six sensors 102 detects real positions (positions) of two drivers 115 (an end part of the driver 115 at the side of the support frame 104). Each of the other three sensors 102 detects a real position of the redundant driver 116 (an end part of the redundant driver 116 at the side of the support frame 104). Thus, each sensor 102 measures position information (the real position) of a connecting point of the driver 115 or the redundant driver 116 with the support frame 104.

A controller 10 controls a plurality of drivers (drivers 115 and redundant drivers 116) so that the real positions of the plurality of drivers come close to target positions based on position information (real positions of the plurality of drivers) obtained from the sensors 102.

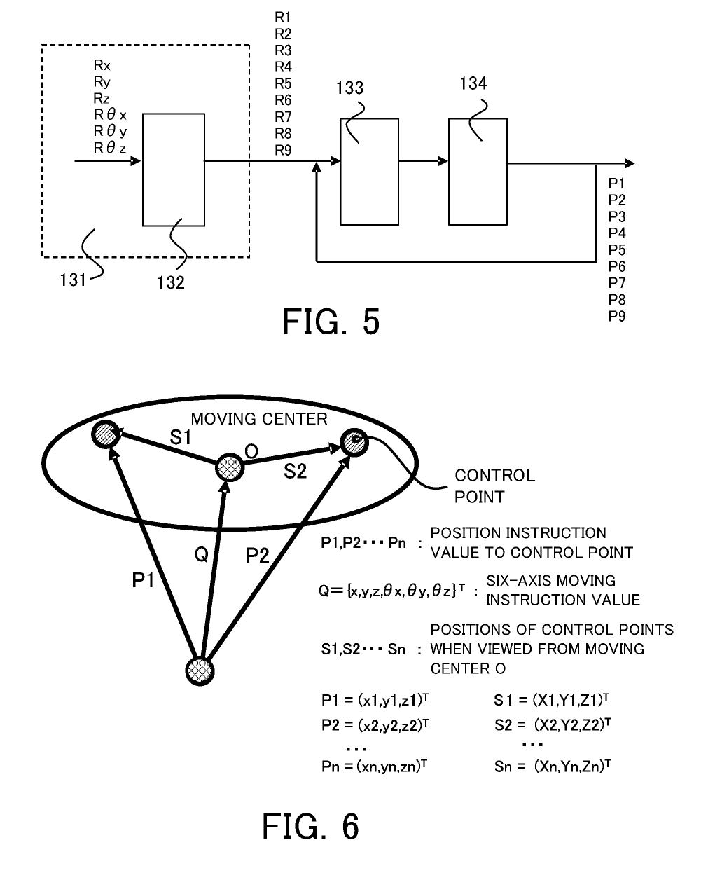

Next, a control performed by the positioning apparatus (the adjusting mechanism) of the present embodiment will be described. FIG. 5 is a control block diagram of the positioning apparatus in the present embodiment.

A target position generator 131 generates a target position of the object such as the optical element that is a driven target based on an instruction of an upper-level controller. The target position of the object is represented as a target position (Rx, Ry, Rz, Rex, Rθy, Rθz) in a coordinate system corresponding to the degrees of freedom. Further, the target position generator 131 includes a coordinate converter 132 (a calculator). The coordinate converter 132 calculates target positions of the plurality of drivers (drivers 115 and redundant drivers 116) using the target position of the object. In other words, the coordinate converter 132 converts the coordinate system indicating the target position of the object (the coordinate system corresponding to the degrees of freedom) to a coordinate system indicating target positions of the plurality of drivers.

As shown in FIG. 5, the target positions of the drivers are represented by target positions R1 to R6 of the six drivers 115 (first drivers) and target positions R7 to R9 of the three redundant drivers 116 (second drivers) using the converted coordinate system. In other words, the plurality of drivers includes the plurality of drivers 115 whose number is equal to that of the degrees of freedom and redundant drivers 116 provided at positions different from those of the drivers 115. The coordinate converter 132 calculates target positions of the plurality of drivers 115 using a target position of a controlled target 134 (object) to set target positions of the redundant drivers 116 on a plane defined by the target positions of the plurality of drivers 115.

Thus, the coordinate converter 132 performs a coordinate conversion so as to maintain a relative position relation among the plurality of drivers (the drivers 115 and the redundant drivers 116). In other words, the coordinate converter 132 performs the coordinate conversion so that all the target positions R1 to R9 are positioned on the same plane.

In the present embodiment, a real shape of the controlled target 134 (object) is previously measured by a sensor (not shown). The coordinate converter 132 performs the coordinate conversion using a measurement result of the shape of the previously measured controlled target 134. Because each object contains a process error, the previously measured object shape is reflected when performing the coordinate conversion to be able to improve the accuracy of the positioning control of the object.

A controller 133 controls the drivers 115 and the redundant drivers 116 so that the controlled target 134 (the object or the drivers) come close to the target positions R1 to R9 obtained by the coordinate conversion based on the target positions R1 to R9. Specifically, real positions of the controlled targets 134 (real positions of the drivers) are detected by sensors (sensors 102). Then, the real positions P1 to P9 measured by these sensors are fed back to the controller 133. The controller 133 compares the target positions R1 to R9 with the real positions P1 to P9, respectively, and controls the plurality of drivers so that the differences become smaller.

The target position generator 131 and the controller 133 including the coordinate converter 132 are for example included in the controller 10 of the exposure apparatus 200.

Next, the coordinate conversion of the present embodiment will be described. FIG. 6 is an illustration of the coordinate conversion in the present embodiment, and shows a coordinate conversion method for maintaining a relative position relation.

In the embodiment, a six-axis instruction value Q of a moving center of a driven target is defined as Q={x, y, z, θx, θy, θz}. In this case, position instruction values P1(x1,y1,z1)^{T}, . . . Pn(xn,yn,zn)^{T} to obtain S1(X1,Y1,Z1)^{T}, . . . Sn(Xn,Yn,Zn)^{T} where control points are represented by object coordinates can be obtained by the following matrix calculation.

$$( \begin{matrix}{x}_{1} \\ {y}_{1} \\ {z}_{1} \\ {x}_{2} \\ {y}_{2} \\ {z}_{2} \\ ⋮\end{matrix} ) = ( \begin{matrix}1 & 0 & 0 & 0 & {Z}_{1} & - {Y}_{1} & {X}_{1} \\ 0 & 1 & 0 & - {Z}_{1} & 0 & {X}_{1} & {Y}_{1} \\ 0 & 0 & 1 & {Y}_{1} & - {X}_{1} & 0 & {Z}_{1} \\ 1 & 0 & 0 & 0 & {Z}_{2} & - {Y}_{2} & {X}_{2} \\ 0 & 1 & 0 & - {Z}_{2} & 0 & {X}_{2} & {Y}_{2} \\ 0 & 0 & 1 & {Y}_{2} & - {X}_{2} & 0 & {Z}_{2} \\ & & & ⋮ & & & \end{matrix} ) ( \begin{matrix}x \\ y \\ z \\ {θ}_{x} \\ {θ}_{y} \\ {θ}_{z} \\ 1\end{matrix} )$$

As described above, the position instruction values to the control points are obtained so as to maintain the relative positions to control the plurality of drivers (the drivers 115 and the redundant drivers 116). Therefore, the deformation of the object (the support frame 104) that is a driven target is suppressed and an accurate positioning control can be performed.

### Embodiment 2

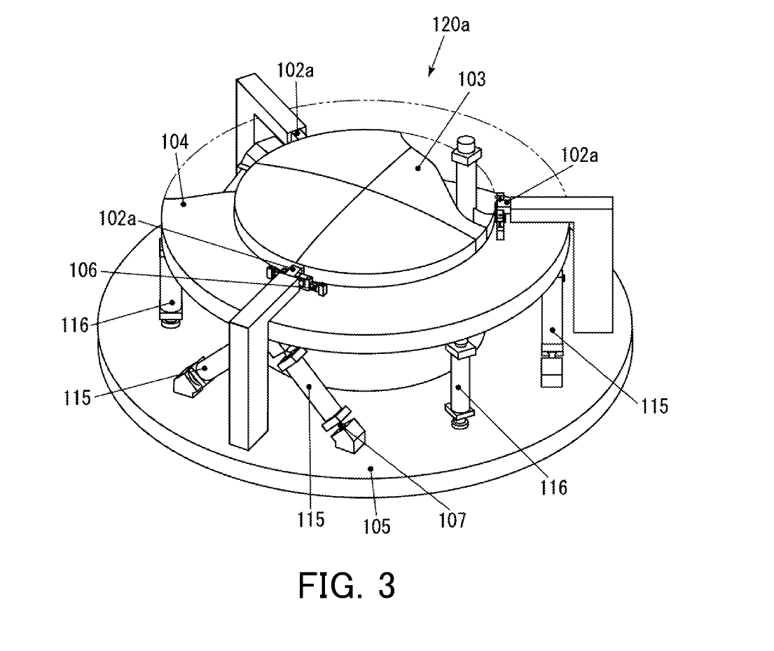

Next, a positioning apparatus in Embodiment 2 of the present invention will be described. FIG. 3 is a configuration diagram of a positioning apparatus (an adjusting mechanism) in the present embodiment.

The adjusting mechanism 120a of the present embodiment is different from the adjusting mechanism 120 of Embodiment 1 in that the adjusting mechanism 120a includes sensors 102a which measure a position of an optical element 103. The adjusting mechanism 120a performs a positioning control for drivers 115 and redundant drivers 116 so as to maintain a relative position relation between each connecting point and a support frame 104 based on position information detected by the sensors 102a. Therefore, the deformation of the support frame 104 that is a driven target is suppressed to be able to perform an accurate positioning control. In order to keep the relative position relations of the connect points of the plurality of drivers (the drivers 115 and the redundant drivers 116) constant, it is preferable that the sensors 102a detect a connecting point of each driver or its adjacent point.

### Embodiment 3

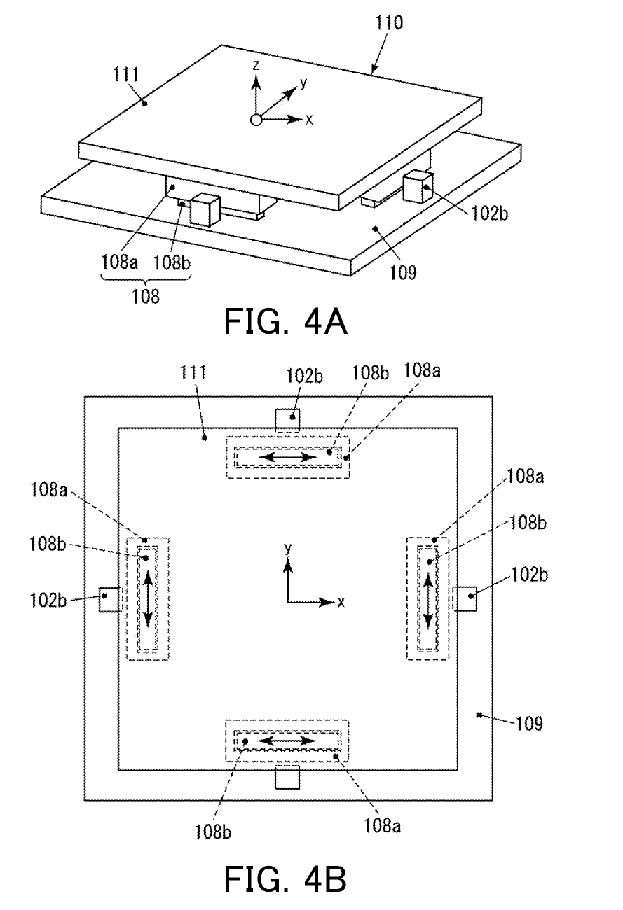

Next, a positioning apparatus in Embodiment 3 of the present invention will be described. FIGS. 4A and 4B are configuration diagrams of a positioning apparatus (a micromotion stage) in the present embodiment. FIGS. 4A and 4B show a perspective view and a plan view of the micromotion stage, respectively.

The micromotion stage of the present embodiment is a micromotion stage 110 using a linear motor 108 (a linear motor mover 108a and a linear motor stator 108b). The micromotion stage 110 includes a plurality of linear motors 108 (four linear motors in the present embodiment) which can be driven in directions horizontal to a surface of a stage plate 111. The stage plate 111 (object) is configured to be driven by the plurality of linear motors 108 to be movable with a total of three degrees of freedom of two translational degrees of freedom and one rotational degree of freedom in a plane (an XY plane in the drawing) parallel to the surface of the stage plate 111.

In order to strengthen a driving force, the micromotion stage 110 of the present embodiment is provided with one more linear motor 108 in addition to the three linear motors 108 which can drive the three degrees of freedom. Further, in the present embodiment, linear motors 108 more than the driving degrees of freedom which can follow the motion of the stage plate 111 are included so that an excessive force is not applied to the stage plate 111 during the driving. The micromotion stage 110 shown in FIGS. 4A and 4B includes only one redundant linear motor 108, but two or more redundant linear motors may also be provided if the number of the linear motors is more than the number of the driving degrees of freedom.

The micromotion stage 110 includes sensors 102b for measuring positions of the linear motor movers 108a (position information of connecting points with the stage plate 111). A positioning control for the plurality of linear motors 108 (the drivers) is performed so as to maintain the relative position relations of the connect points with the stage plate 111 based on the position information of the sensors 102b. The positioning control is performed so as to maintain the relative position relation among the plurality of linear motors 108 to suppress the deformation of the stage plate 111 that is a driven target to be able to perform an accurate positioning control.

A device (a semiconductor integrated circuit device, a liquid crystal display device, or the like) is manufactured by a step of exposing a substrate (a wafer, a glass plate, or the like) which is coated by a photosensitizing agent using an exposure apparatus in any one of the above embodiments, a step of developing the substrate, and other well-known steps.

In each of the above embodiments, the example where the positioning apparatus is applied to an optical element adjusting mechanism of the exposure apparatus or the micromotion stage using the linear motor has been described, but the positioning apparatus of the present invention is not limited to these examples.

As described above, according to each of the above embodiments, the drivers more than the driving degrees of freedom are provided, and the positioning control is performed so as to maintain the relative position relation among the plurality of drivers. Therefore, the deformation of the object that is a driven target is suppressed to be able to perform an accurate positioning. According to each of the above embodiments, a highly accurate positioning apparatus which improves the rigidity can be provided. Further, according to each of the above embodiments, highly accurate exposure apparatus and device manufacturing method can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-024853, filed on Feb. 5, 2009, which is hereby incorporated by reference herein in its entirety.

What is claimed is:

1. A positioning apparatus which performs a positioning of an object with a predetermined number of degrees of freedom, the positioning apparatus comprising:
a plurality of drivers whose number is more than that of the degrees of freedom, which are configured to drive the object;
a calculator configured to calculate target positions of the plurality of drivers from a target position of the object using a measurement result of a shape of the object previously measured; and
a controller configured to control the plurality of drivers so as to come close to the target positions of the plurality of drivers.

2. A positioning apparatus according to claim 1,
wherein the plurality of drivers includes a plurality of first drivers whose number is the same as that of the degrees of freedom and a second driver which is different from the first drivers, and
wherein the calculator calculates target positions of the plurality of first drivers on the basis of the target position of the object to set a target position of the second driver on a plane defined by the target positions of the plurality of first drivers.

3. A positioning apparatus according to claim 1, further comprising detectors configured to detect positions of a part of the plurality of drivers,
wherein the controller controls the plurality of drivers so as to reduce a difference between the target positions and the detected positions of the plurality of drivers.

4. A positioning apparatus according to claim 1,
wherein the plurality of drivers are piezo actuators.

5. An exposure apparatus which exposes a pattern of an original plate onto a substrate, the exposure apparatus comprising:
a positioning apparatus configured to perform a positioning of an object with a predetermined number of degrees of freedom,
wherein the positioning apparatus comprises:
a plurality of drivers whose number is more than that of the degrees of freedom, which are configured to drive the object;
a calculator configured to calculate target positions of the plurality of drivers from a target position of the object using a measurement result of a shape of the object previously measured; and
a controller configured to control the plurality of drivers so as to come close to the target positions of the plurality of drivers.

6. A device manufacturing method comprising the steps of:
exposing a substrate using an exposure apparatus; and
developing the exposed substrate,
wherein the exposure apparatus comprises a positioning apparatus configured to perform a positioning of an object with a predetermined number of degrees of freedom, and
wherein the positioning apparatus comprises:
a plurality of drivers whose number is more than that of the degrees of freedom, which are configured to drive the object;
a calculator configured to calculate target positions of the plurality of drivers from a target position of the object using a measurement result of a shape of the object previously measured; and
a controller configured to control the plurality of drivers so as to come close to the target positions of the plurality of drivers.
